(19) United States
(12) Patent Application Publication
(10) Pub. No.: US 2012/0094017 A1
(43) Pub. Date: Apr. 19, 2012

(54) Patterned Nanoparticle Assembly Methodology

(75) Inventors: Thomas M. Crawford, Irmo, SC (US); Jason Henderson, Taylors, SC (US)

(73) Assignee: UNIVERSITY OF SOUTH CAROLINA, Columbia, SC (US)

(21) Appl. No.: 13/276,774

(22) Filed: Oct. 19, 2011

Related U.S. Application Data
(60) Provisional application No. 61/455,366, filed on Oct. 19, 2010.

(51) Int. Cl. B05D 5/00; B05D 3/10

(52) U.S. Cl. 427/130

(57) ABSTRACT

Methods for creating a precision assembly of nanoparticles by controlled deposition from a colloidal fluid (e.g., a ferrofluid) are disclosed. The method can include assembling magnetic nanoparticles, fixing the nanoparticles in place, and then allowing the completed nanoparticle assembly to be washed and dried to remove unwanted process contaminants left in the assembly fluid while preserving the underlying nanoparticle assembly as designed.

### PRIORITY INFORMATION

The present application claims priority to U.S. Provisional Patent Application Ser. No. 61/455,366 of Crawford, et al. titled “Patterned Nanoparticle Assembly Methodology” filed on Oct. 19, 2010, the disclosure of which is incorporated by reference herein.

### GOVERNMENT SUPPORT CLAUSE

This invention was made with government support under CMMI-0700458 awarded by National Science Foundation. The government has certain rights in the invention.

### BACKGROUND

As described in U.S. Publication No. 2010/0279024 entitled: “Reprogrammable Parallel Nanomanufacturing” of Thomas Crawford, which is incorporated by reference herein, magnetic recording can be employed to generate nanoscale magnetic field patterns on the surface of magnetic media. By exposing the surface containing these nanoscale patterns to a colloidal fluid containing magnetic nanoparticles (ferrofluid), nanoscale patterns with macroscopic dimensions can be created which are both programmable and re-programmable.

However, in order to keep ferrofluids well-dispersed in the fluid such that the nanoparticles do not clump together, when synthesized, the nanoparticles are coated with a chemical surfactant (for example, oleic acid). The actual process by which the particles do not aggregate involves a finite electrostatic charge on the surfactant molecules themselves. Since all of the magnetic nanoparticles have this surfactant coating on their surface, either electrically positive or negative, the net effect is that if the particles approach one another, a repulsive electrostatic force keeps them from aggregating into larger assemblies.

The negatively charged nanoparticle surfactant exerts a force that tries to push the nanoparticles away from each other, while the magnetic force tries to pull them toward the surface. Once assembled, this Coulomb repulsive force opposes the magnetic force pulling the particles to the surface and to each other. While nanoparticles can be assembled in fluid into patterns based on the underlying magnetic field nanostructure, the Coulomb repulsion, together with strong currents within the suspension fluid and the fluid surface tension as it dries, can be sufficient to overcome the magnetic force holding the particles to the surface and pull the assembled particles away from the surface of the media, such that when the fluid is removed, so is the pattern.

As such, a need exists for improved methods of forming a nanoparticle assembly on a magnetic media.

### SUMMARY

Objects and advantages of the invention will be set forth in part in the following description, or may be obvious from the description, or may be learned through practice of the invention.

Methods are generally provided for forming a nanoparticle assembly. In one embodiment, a colloidal fluid that includes magnetic nanoparticles (e.g., iron-containing particles), a surfactant (e.g., oleic acid, tetramethylammonium hydroxide, citric acid, soy lecithin, or a mixture thereof), and a carrier medium can be applied to a surface of a magnetic media, and the magnetic nanoparticles can be assembled into a pattern through a magnetic force arising from the surface of the magnetic media. Thereafter, a buffer solution can be added to the surface of the magnetic media. For example, the buffer solution can remove contaminants left in the assembly fluid while preserving the underlying nanoparticle assembly.

In one particular embodiment, the buffer solution can be a salt solution (e.g., a phosphate buffer). The buffer solution can include, for example, a positive ion-containing salt solution, which can pacifie a negative charge on the magnetic nanoparticles such that a repulsive electrostatic force is reduced compared with the magnetic force.

The magnetic nanoparticles of the colloidial fluid can, in one embodiment, be coated with the surfactant. For instance, the surfactant can have a polar head and non-polar tail such that one of the polar head or non-polar tail adsorbs into the magnetic nanoparticle while the other extends into the carrier medium to form an inverse or regular micelle around the particle such that steric repulsion prevents agglomeration of the magnetic nanoparticles.

Additional steps may also be included in the methods, as desired. For example, a soap solution can be added to the surface of the magnetic media after adding the buffer solution such that the soap solution washes away clumped nanoparticles, buffer salts, and contaminants without disturbing the magnetic nanoparticles which are magnetically assembled. Additionally, the surface of the magnetic media can be washed with deionized water after adding the soap solution.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 shows a plurality of magnetic nanoparticles attracted to the surface by a magnetic force while the surfactant charge inhibits nanoparticle aggregation;

FIG. 2 shows pacification of the surfactant charge with a buffer solution;

FIG. 3 shows the soap solution and deionized water washes away clumped nanoparticles, buffer salts, and contaminants without disturbing the magnetic nanoparticles which are magnetically assembled; and

FIG. 4 shows an example of a highly ordered nanoparticle assembly with virtually no extra particulate matter obtained using one particular method described according to the examples.

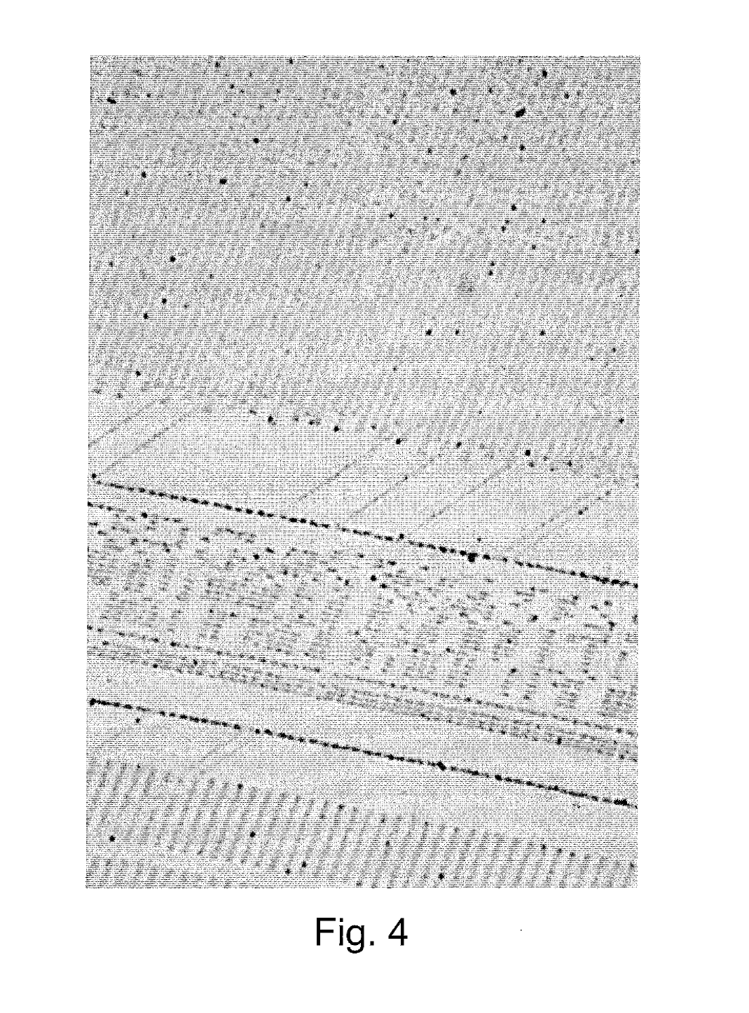

Repeat use of reference characters in the present specification and drawings is intended to represent the same or analogous features or elements of the present invention.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

Methods are generally disclosed for creating a precision assembly of nanoparticles by controlled deposition from a colloidal fluid (e.g., a ferrofluid). The method generally includes assembling magnetic nanoparticles, fixing the nanoparticles in place, and then allowing the completed nanoparticle assembly to be washed and dried to remove unwanted process contaminants left in the assembly fluid while preserving the underlying nanoparticle assembly as designed.

In particular, the presently disclosed methods can allow for a reliable coating of nanoparticles to be obtained after the excess colloidal fluid (e.g., ferrofluid) is removed from the surface of the magnetic media (e.g., disk). In this approach to assembly, the magnetic nanoparticles can be assembled into patterns by the magnetic force arising from a strong magnetic field gradient at the media surface which is caused by the spatial localization from which the fields are emitted.

In one embodiment, a colloidal fluid that includes magnetic nanoparticles (e.g., iron-containing particles), a surfactant (e.g., oleic acid, tetramethylammonium hydroxide, citric acid, soy lecithin, or a mixture thereof), and a carrier medium can be applied to a surface of a magnetic media and allowed to assemble into a pattern through a magnetic force arising from the surface of the magnetic media. Thereafter, a buffer solution can be added to the surface of the magnetic media to pacify the charge of the surfactant in order to allow for agglomeration of the magnetic nanoparticles in the desired pattern on the magnetic media. Optionally, a soap solution can be added to the surface of the magnetic media after adding the buffer solution in order to wash away clumped nanoparticles, buffer salts, and contaminants without disturbing the magnetic nanoparticles which are magnetically assembled.

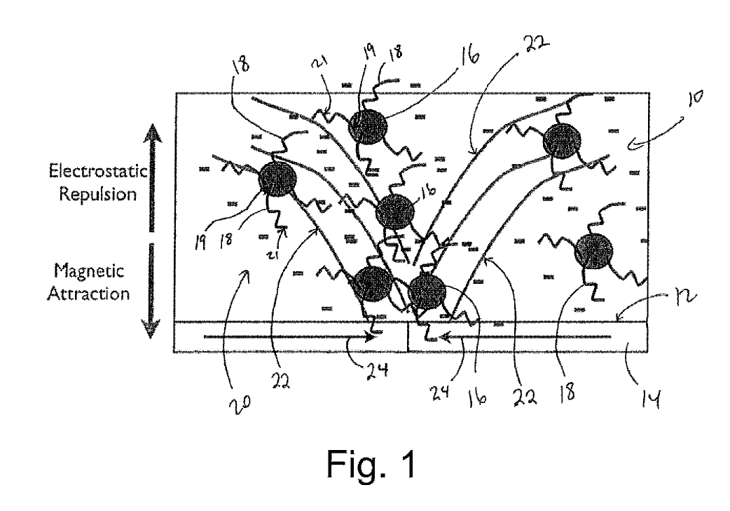

FIGS. 1-3 sequentially show one particular embodiment of such a method. As shown in FIG. 1, the colloidal fluid 10 is applied to a surface 12 of a magnetic media 14. The colloidal fluid 10 generally includes magnetic nanoparticles 16 and a surfactant 18 dispersed within a carrier medium 20. The magnetic nanoparticles 16 can be any suitable nanoparticles that magnetically interact with the magnetic media 14. For example, the magnetic nanoparticles 16 can be iron-containing particles (i.e., comprising iron), such as magnetite, hematite, another iron-containing compound, or mixtures thereof. The magnetic nanoparticles 16 can have an average size of about 100 nanometers or less (e.g., about 5 nanometers to about 25 nanometers).

The surfactant 18 can, in one embodiment, interact with the magnetic nanoparticles 16 such that the nanoparticles 16 are coated with the surfactant 18. For example, the surfactant 18 can generally define a polar head and non-polar tail. In one particular embodiment, one of the polar head or non-polar tail is adsorbed into the magnetic nanoparticle 16 while the other extends into the carrier medium 20 to form an inverse or regular micelle around the nanoparticle 16 such that steric repulsion prevents agglomeration of the magnetic nanoparticles 16. As shown, the nonpolar head 19 of the surfactant 18 is absorbed into the magnetic nanoparticles 16, while the polar tail 21 extends into the carrier medium 20.

In particular embodiments, the surfactant 18 can be oleic acid, tetramethylammonium hydroxide, citric acid, soy lecithin, or a mixture thereof.

As shown in FIG. 1, the magnetic nanoparticles 10 can assemble into a pattern through a magnetic force (lines 22) arising from the surface 12 of the magnetic media 14 after the colloidal fluid 10 is applied thereon, whereby the nanopoarticles 16 are attracted along the magnetic field lines 22 to a transition in the underlying magnetic media 14. For example, the magnetic transition (shown as arrows 24 in magnetic media 14) creates a spatially varying magnetic field, and enhances a magnetic force (lines 22) in the colloidal fluid 10. Negatively charged magnetic nanoparticles 16 are attracted to the transition, but are still feeling a repulsive force (see opposing force vectors at left) due to the surfactant charge attached to the nanoparticles 16.

Specifically, the magnetic force lines from the magnetic media 14 attracts the magnetic nanoparticles 16 to the media's surface 12. However, the surfactant charge on the magnetic nanoparticles 16, which is designed to prevent aggregation thereof, opposes the magnetic force that is pulling the nanoparticles 16 together in the pattern. The particular pattern can be varied as desired through adjusting the magnetic media 14.

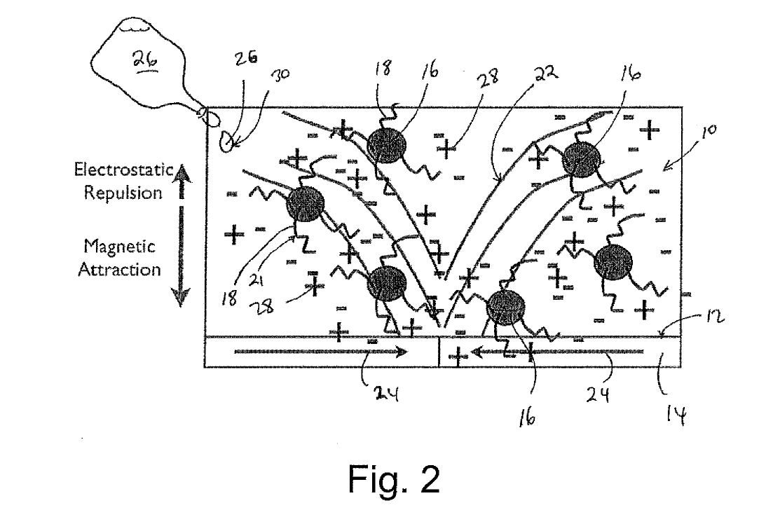

After the colloidal fluid 10 is applied onto the surface and the magnetic nanoparticles are assembled into the desired pattern, a buffer solution 26 can be added to the colloidal fluid 10 on the surface 12 of the magnetic media 14 as shown in FIG. 2. The buffer solution 26 can generally remove contaminants left in the assembly fluid while preserving the underlying nanoparticle assembly. Generally, the buffer solution 26 can serve to pacify a charge on the magnetic nanoparticles 16 such that the repulsive electrostatic force between adjacent magnetic nanoparticles 16 is reduced without affecting the magnetic force between the nanoparticles 16 and the magnetic media 14.

In one particular embodiment, the buffer solution 26 can be a salt solution (e.g., a phosphate buffer). The buffer solution 26 can include, for example, a positive ion-containing salts 28, which can pacify a negative charge on the magnetic nanoparticles 16 such that a repulsive electrostatic force is reduced compared with the magnetic force 22. Specifically, the buffer solution 26 including a salt 28 can neutralize the surfactant charge after magnetic assembly but before the colloidal fluid 10 is removed from the surface 14.

By adding a few drops 30 of the buffer solution 26 to the colloidal fluid 10 at some point after the colloidal fluid 10 has been applied to the surface 12 and the nanoparticles 16 have had a chance to assemble on the surface 16, disruption and removal of the nanoparticles 16 as the colloidial fluid 10 is removed/dried can be avoided to yield a layer of assembled nanoparticles 16 on the surface 12.

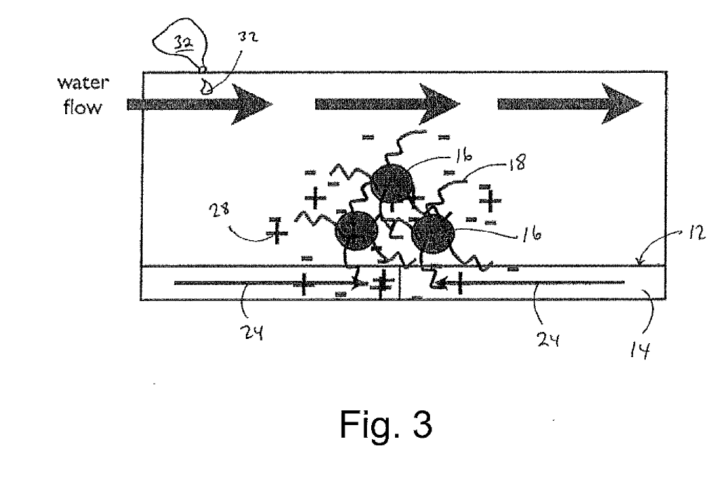

Additional steps may also be included in the methods, as desired. For example, a soap solution 32 can be added to the colloidal fluid 10 on the surface of the magnetic media 12 after adding the buffer solution 26 as shown in FIG. 3. Because the passivation of surfactant charges occurs throughout the fluid 10 and not just at the media surface 12, the addition of the buffer solution 26 may not sufficiently yield a clean nanoparticle patterned surface 12. To prevent particle clumping from forming large aggregates which can dirty and mar the nanoparticle pattern on the surface 12, an additional surfactant can be added in the form of a soap solution 32, as shown schematically in FIG. 3. The soap solution 32 can rinse or otherwise wash away any clumped nanoparticles, buffer salts, and/or contaminants on the surface without substantially disturbing the magnetic nanoparticles which are magnetically assembled. Additionally, the surface 12 of the magnetic media 14 can be washed with deionized water after adding the soap solution 32. Thus, a clean surface 12 having the pattern of magnetic nanoparticles 16 thereon can be left.

The surfactant of the soap solution 32 can recoat unattached nanoparticles 16 still in fluid 10 that have clumped together. These recoated particles therefore do not substantially attach to the surface 12 of the magnetic media 14 and are easily washed away (e.g., with fresh deionized water).

The ability to wash and then allow the surface 12 to dry without damaging the assembled nanoparticle pattern is critical to obtaining large area nanomanufactured assemblies with nanometer precision tolerances. Here, as the assembled nanoparticles 16 are strongly bound to the surface 12 by the magnetic force and do not wash away, the surface pattern can be preserved with the deionized water wash that can flush the media surface and remove any remaining soap or buffer material. Thus the media dries cleanly without forming salt crystals or retaining debris. Thus, the presently disclosed methods can yield well defined features of assembled magnetic nanoparticles that remain after drying while preventing undesired material from remaining on the media surface.

Alternative particle, salt and surfactant combinations may be used in accordance with the presently disclosed methods, assuming that they undergo the process described above. Namely, the particles do not substantially bind together under their own electrostatic or magnetic attractions yet can be set to do so with the addition of neutralizing ions, and the effects of the ionizing salt (particle clumping, precipitation, adhesion) can be overcome by surrounding the particles with additional surfactant prohibiting further contributions to the established assemblage thus leaving it clean and intact.

Applications of these methods are particularly relevant in the nanomanufacture of transparent assemblies containing patterned nanostructures. Examples can include structures such as a nanoassembled diffraction grating, a plasmonic optical antenna or concentrator for solar energy applications, i.e. photovoltaics or artificial photosynthesis. If the nanoparticles are coated with biomaterials such as DNA, peptides, or proteins, these structures could act as cell sorters or optically readable biosensor technologies. Such assemblies could represent a secret bar code technology for sensitive items that need to be tracked without someone knowing they are being tracked. So multiple military, commercial, defense, and energy applications exist for the presently disclosed methods to manufacturing assemblies of patterned nanostructures.

### Example

FIG. 5 shows an example of a highly ordered nanoparticle assembly with virtually no extra particulate matter obtained using this reduced-to-practice approach to nanoparticle assembly.

To obtain the pattern of FIG. 5, a preprogrammed 15 mm diameter magnetic substrate was covered with 400 μL of Ferrotech magnetite ferrofluid (Nashua, NH-EMG 707) for three minutes, introduced 50 μL of Titristar® Phosphate Buffer (VWR, inc) with a pH of 7.20+/−0.05%, and then immediately added 200 μL of soap solution as a surfactant. The substrate was then rinsed with deionized water until suspended particulates were no longer visible under an optical microscope. The nanoparticles have a mean diameter of 13 nm with a zeta potential of −50 mV and were used as supplied from Ferrotech, except the ferrofluid concentration was decreased to less than 0.1%. The buffer solution contains sodium phosphate (dibasic, anhydrous), potassium phosphate (monobasic and dibasic), ammonium chloride, and more than 93% water by weight. The soap solution at a concentration of 30:1 deionized water to Dawn Ultra dish detergent, comprising both anionic and nonionic surfactants, has sodium alkyl sulfide, SD alcohol, sodium alkyl ethoxylate sulfate, and alkyl dimethyl amine oxide as its ingredients.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part, Furthermore, those of ordinary skill in the art will appreciate that the foregoing description is by way of example only, and is not intended to limit the invention so further described in the appended claims.

What is claimed:

1. A method of forming a nanoparticle assembly, the method comprising:
applying a colloidal fluid to a surface of a magnetic media, wherein the colloidal fluid comprises magnetic nanoparticles, a surfactant, and a carrier medium;
assembling the magnetic nanoparticles into a pattern through a magnetic force arising from the surface of the magnetic media; and
thereafter, adding a buffer solution to the colloidal fluid on the surface of the magnetic media.

2. The method as in claim 1, wherein adding the buffer solution removes contaminants left in the assembly fluid while preserving the underlying nanoparticle assembly.

3. The method as in claim 1, wherein the buffer solution comprises a salt solution.

4. The method as in claim 3, wherein the salt solution comprises a phosphate buffer.

5. The method as in claim 3, wherein the buffer solution has a pH of about 7 to about 8.

6. The method as in claim 3, wherein the buffer solution comprises a positive ion-containing salt solution.

7. The method as in claim 6, wherein the buffer solution pacifies a negative charge on the magnetic nanoparticles such that a repulsive electrostatic force is reduced compared with the magnetic force.

8. The method as in claim 1, wherein the magnetic nanoparticles are coated with the surfactant.

9. The method as in claim 8, wherein the surfactant has a polar head and non-polar tail, and wherein one of the polar head or non-polar tail adsorbs into the magnetic nanoparticle while the other extends into the carrier medium to form an inverse or regular micelle around the particle such that steric repulsion prevents agglomeration of the magnetic nanoparticles.

10. The method as in claim 1, wherein the surfactant comprises oleic acid, tetramethylammonium hydroxide, citric acid, soy lecithin, or a mixture thereof

11. The method as in claim 1, wherein the magnetic nanoparticles comprise iron.

12. The method as in claim 1, wherein the magnetic nanoparticles comprise magnetite, hematite, another iron-containing compound, or mixtures thereof.

13. The method as in claim 1, wherein the magnetic nanoparticles have an average size of about 100 nanometers or less.

14. The method as in claim 1, wherein the magnetic nanoparticles have an average size of about 5 nanometers to about 25 nanometers.

15. The method as in claim 1, further comprising:
adding a soap solution to the surface of the magnetic media after adding the buffer solution.

16. The method as in claim 15, wherein the soap solution comprises water and a second surfactant.

17. The method as in claim 15, wherein the water is deionized water.

18. The method as in claim 15, wherein the soap solution washes away clumped nanoparticles, buffer salts, and contaminants without disturbing the magnetic nanoparticles which are magnetically assembled.

19. The method as in claim 15, further comprising:
washing the surface of the magnetic media with deionized water after adding the soap solution.
